(19) United States
(12) Patent Application Publication
(10) Pub. No.: US 2014/0109424 A1
(43) Pub. Date: Apr. 24, 2014

(54) Bendable Measuring Device

(71) Applicants: Jayson Leff, Purvis, MS (US); Ryan Bryson, Purvis, MS (US)

(72) Inventors: Jayson Leff, Purvis, MS (US); Ryan Bryson, Purvis, MS (US)

(21) Appl. No.: 13/655,383

(22) Filed: Oct. 18, 2012

(51) Int. Cl. G01B 3/10

(52) U.S. Cl. 33/701; 33/755; 33/771

(57) ABSTRACT

A measuring tool is formed from a malleable flexible bendable non-resilient material as an elongated planar strip. The planar tool has measuring indicia formed on at least one of the tool's planar surfaces. When the tool is placed in contact with an object, it can be bent to conform to the contact surface of the object. The tool retains the conformed shape for any desired period of time without returning to its normal planar configuration, thus allowing the user to trace the object or record measurements of the object.

### BACKGROUND OF THE INVENTION

The present invention relates measuring instruments and, more particularly to a hand-held measuring device that can be used in a variety of length-measuring tasks.

When measuring floor for installation of floor covering, such as parquet, carpet and the like, it is important to measure various uneven surfaces, protrusions in the walls, irregularities, door jambs, moldings and other such surfaces. Conventional measuring devices in the form of straight rulers are of little help since the multiple angles in the wall surface make the task time consuming and laborious.

Another conventional device, a flexible measuring tape is similarly difficult to use since the user has to hold the measuring tape against the wall surface when taking a measurement of every irregularity. Other measuring tasks are similarly time consuming. For instance, when a user installs pipes or pipe supports, the user will need to use a flexible tape to encircle the pipe and hold two sections of the tape around the object or, with multiple pipes, run the tape around two or more pipes. In such cases, an assistant or apprentice holds the tape and calls out the measurements, which the installer will eventually use. Needless to say, a second person on the job increases the cost of the job and in some cases is prohibitively expensive.

One of the known solutions to this problem is discussed in U.S. Pat. No. 1,233,382, which discloses a sectional or tubular length of rubber capable of being bent without breaking. It is provided on one or both sides with lateral longitudinal flanges, which may reduce in thickness. The flanges are molded integrally with the hollow flexible strip.

Another known example is U.S. Pat. No. 2,790,245, which discloses a drafting spline using a strip of spring steel, to which a strip of sponge rubber is glued. The rubber strip has the same dimensions as the metal strip. The top surface of the rubber strip is flush with the top of the metal strip, while the underside of the rubber strip is beveled at 5° relative to the horizontal plane of the surface on which the spline rests. When the spline is in a vertical position it is designed to rest on the beveled surface.

A method of manufacturing a flexible measuring tape is disclosed in U.S. Pat. No. 2,471,395, where a metal strip is coated with a protective coating of light or light reflective material. The coating, when hardened, retains flexible characteristics. The coating is strong enough to withstand multiple bending actions. A drafting instrument having flexibility and magnetic properties is disclosed in U.S. Pat. No. 3,724,083, where the drafting device is made in the form of two elongate strips of flexible elastomeric material, with the strips clinging tightly together, side-by-side, to form a laminated flexible drafting spline, which also clings magnetically to a sheet steel drawing board.

The use of magnetic material is also discussed in U.S. Pat. No. 4,539,757, magnetic beads are secured within the curve strip. When the draftsman prepares a drawing upon a magnetic pad and utilizes the curve strip, the steel beads within the curve strip are attracted to the magnetic pad thereby fixing the curve stripe in any curve desired by the draftsman. The curve strip includes a core of a soft pliable metal and a long iron strip which is flat, rectangular in cross section and placed adjacent the soft metal core when the two of them are encased in a pliable plastic jacket. The core is provided with a series of openings for receiving a plurality of magnetic beads. The back surface of the beads is flat and mates with the flat surface of opening to prevent the beads from moving at will and to make the other sides of the plurality of beads to be firmly drawn by the associated magnetic pad.

U.S. Pat. No. 6,167,633 discloses two flexible, elongated members which are joinable together by preferably releasable attachment means to form, or conform to, the shape of complex curves. One flexible member includes a plurality of projections rigidly affixed to and disposed along the length of the flexible member. Each projection extends outwardly perpendicular to the flexible member and includes an end face which is parallel to the flexible member. The attachment means preferably comprises hook-and-loop fasteners with one portion of the hook-and-loop fasteners affixed to the end face of each projection, and the complementary portion of the hook-and-loop fastener affixed to preferably the entire surface of the opposite flexible member.

U.S. Publication No. 2008/0005915 discloses the use of a flexible tube that is in the form of an electrical conduit and which has measurements imprinted thereon. The ruler can be flexed and placed in the exact location and positions that will be occupied by a flexible conduit or cable and will traverse exactly the same distance as the installed conduit or cable. A plurality of ribs is defined on the ruler to enable that ruler to bend and twist.

While these devices satisfy a particular purpose, there is a need in an inexpensive flexible bendable measuring device that can be used in various industries and applications. The present invention provides such a device.

### SUMMARY OF THE INVENTION

It is, therefore, an object of the present invention to provide a flexible bendable measuring device that is easy to use and inexpensive to manufacture.

It is another object of the invention to provide a flexible bendable ruler that can be used in a variety of applications.

It is a further object of the invention to provide a non-resilient flexible bendable ruler that retains the shape of the measured peripheries without snapping back to its original shape.

These and other objects of the invention are achieved through a provision of a measuring device that is formed from a malleable flexible bendable non-resilient material in the shape of an elongated planar strip. The planar tool has measuring indicia formed on at least one of the tool's planar surfaces along at least one elongated edge. When the tool is placed in contact with an object, it can be bent to conform to the contact surface of the object. The tool retains the conformed shape for any desired period of time without returning to its normal planar configuration, thus allowing the user to trace the object or record measurements of the object.

### BRIEF DESCRIPTION OF THE DRAWINGS

Reference will now be made to the drawings, wherein like parts are designated by like numerals, and wherein

FIG. 1 is a perspective view of the measuring device according to the present invention.

FIG. 2 is a perspective view illustrating the measuring device suspended from a waist belt of a user.

FIG. 3 illustrates the measuring device of the present invention retaining the shape of a door frame that has been measured.

FIG. 4 illustrates the use of the measuring device of the present invention around a tubular object.

FIG. 5 illustrates the use of the measuring device of the present invention positioned about adjacent tubular objects.

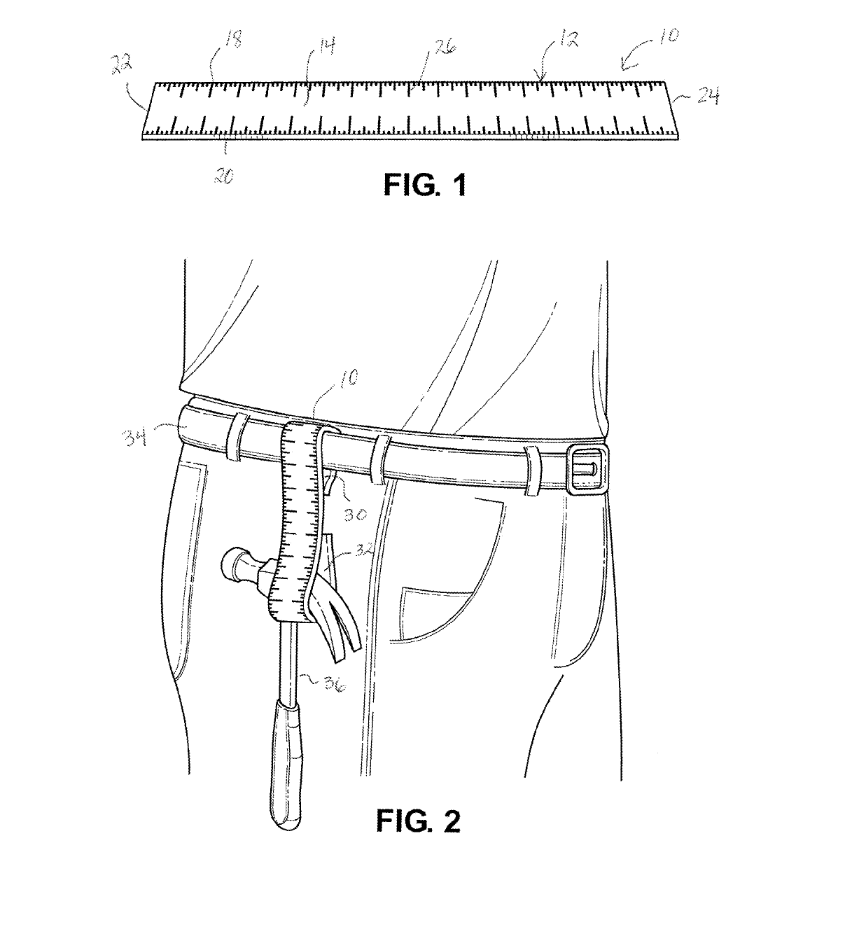

### DETAIL DESCRIPTION OF THE INVENTION

Turning now to the drawings in more detail, numeral 10 designates the measuring device of the present invention. The device 10 comprises an elongated strip 12 having a first planar surface 14 and a second planar surface 16, which extends opposite and parallel to the first planar surface 14. The strip 12 has opposing elongated measuring edges 18 and 20, and opposing ends 22, 24. The strip 12 has a predetermined thickness allowing the strip 12 to maintain a vertical orientation, when necessary, when resting on the edge 18 or the edge 20.

Measuring indicia 26 is imprinted, engraved, or otherwise formed on one or both planar surfaces 14 and 16 along the measuring edges 18 and 20. The measuring indicia include successive measuring marks located adjacent to and extending along the length of the measuring edges 18 and 20. Each individual measuring mark corresponds to fractional or decimal value depending on the type of measuring system used. If desired, fractional values can be displayed along the measuring edge 18 and decimal metric values can be displayed along the opposite measuring edge 20. The measuring indicia can be formed on either one or both planar surfaces 14 and 16.

The strip 12 is formed as a non-resilient flexible bendable body formed from a malleable material, for instance lead or lead alloy. Of course, other materials having high malleability can be used. It is preferred that the strip 12 be made from a material having suitable plasticity and resistant to fracture. In this manner, the strip 12 can be bent and reshaped numerous times without breaking or sustaining permanent deformation. While the strip 12 has a normally planar configuration, the malleable non-resilient strip 12 is disposed to conform to a shape of an object being measured and to maintain the conformed shape for a desired period of time without returning to the normally planar configuration.

FIGS. 2-5 illustrate some examples of the use of the measuring device 10. FIG. 2 illustrates the measuring device 10 bent to form two suspension loops 30 and 32. The suspension loop 30 is used to wrap the strip 12 around a waist belt 34 of the user, while the loop 32 is used to support a hammer 36. It will be understood that the sizes and creation of the loops 30 and 32 is arbitrary, and only one loop can be formed for retaining the measuring device in an easy-to-access position on the user's clothing. The waist belt 34 can be a tool belt, if desired.

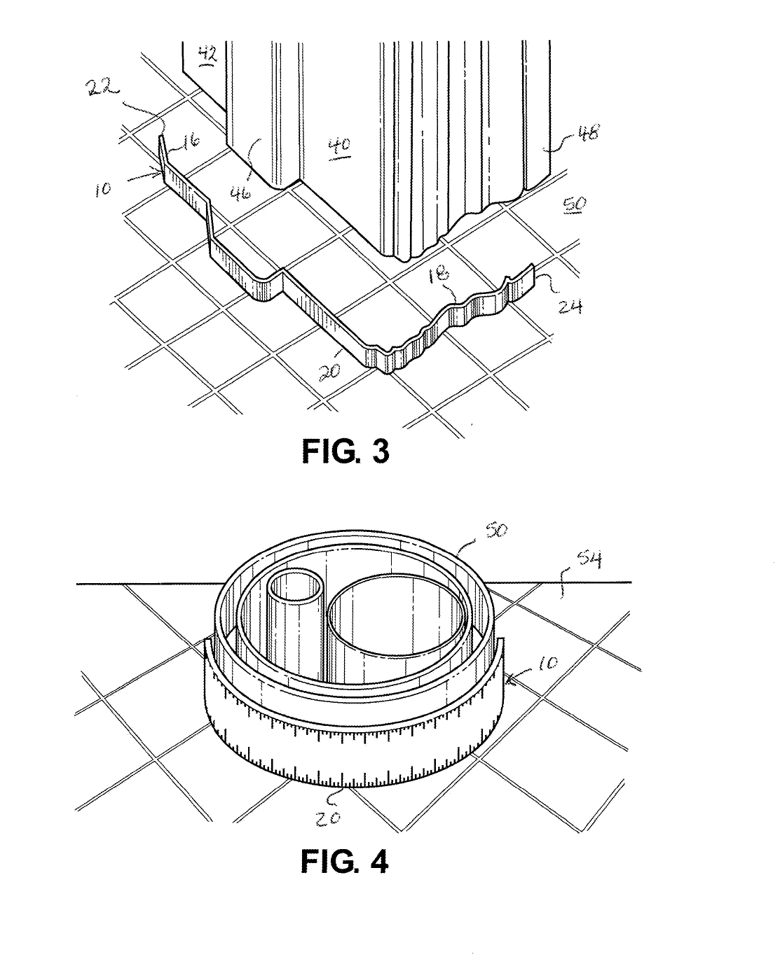

FIG. 3 illustrates the measuring device 10 used for measuring complex surfaces, such as a door jamb. In this example, the measuring device 10 is positioned vertically to rest on the measuring edge 20. As can be seen in the drawing, vertical walls 40 and 42 are separated by a door frame 46. Moreover, an adjacent vertical wall 48 has multiple irregularities at the interface with the floor surface 50. The measuring device 10 has been bent to closely follow the walls 40, 42 and 48 and in effect to mimic the projections formed by the door frame 46 and irregularities in the wall 48.

The measuring device 10 is seen self-supported on the floor 50 while resting on the measuring edge 20. A user can transfer the measuring device 10 to a floor covering (carpet, wood or tile) and use the measuring device 10 as a template in cutting the floor covering for this particular section of the floor 50.

FIG. 4 illustrates the measuring device 10 used for measuring tubular objects. In this illustration, the measuring device 10 is positioned vertically and rests on the measuring edge 20. The strip 12 is bent to closely follow the circumference of a tubular object 52. A user can effectively measure the diameter of the tubular object 52 or faun a template for a cut in a floor 54 corresponding to the tubular object 52.

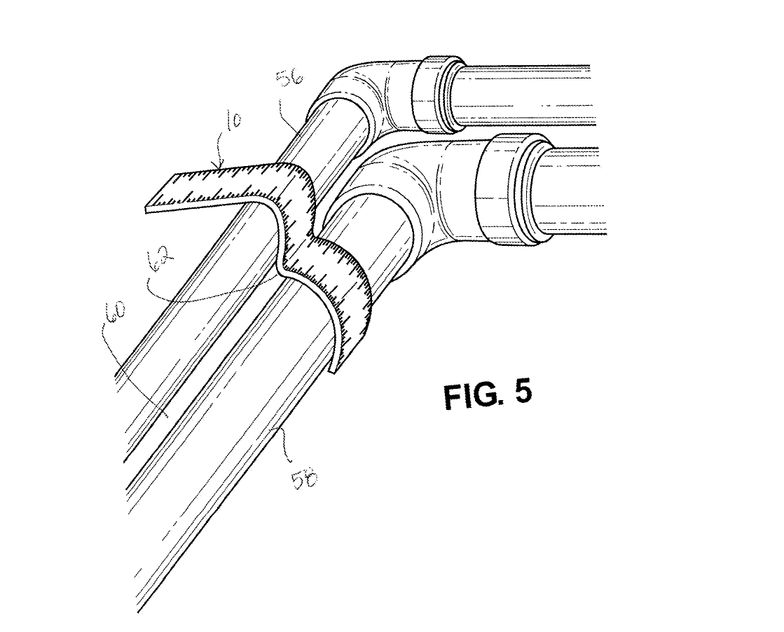

FIG. 5 illustrates the use of the measuring device 10 for measuring adjacent tubular objects 56 and 58. The pipes 56, 58 may be positioned on a horizontal surface or suspended on a wall. The pipes 56 and 58 may have the same diameter or different diameters. Regardless of these factors, the pipes 56 and 58 may need to be connected by a clip or bracket. In such a case, the measuring device 10 becomes a measuring tool for extending around the circumference of the pipes and across a gap 60 between the pipes 56, 58. The measuring device 10 closely follows the portions of the pipes 56, 58 that need to be secured by a clip or bracket and forms a bend 62, where the clip needs to span across the gap 60.

The present invention also provides a method for tracing a contour of an object. According to the method, a measuring device is provided, the device comprising an elongated malleable strip having a normally planar configuration, a first planar surface, a second planar surface oriented parallel to the first planar surface, a first elongated edge and a second elongated edge, and measuring indicia formed on at least the first planar surface along at least the first elongated edge.

The method also includes the steps of placing the flexible strip proximate the object being traced, adjusting the strip sufficient to permit at least a portion of the strip to contact the object being traced and conform to a shape of contact surface of the object being traced. The method also includes the steps of removing the strip from contact with the object being traced and recording measured dimensions of the object being traced. The strip 12 being formed from a malleable non-resilient material is disposed to conform to the shape of the object being traced and measured and to maintain conformed shape for a desired period of time without returning to the normally planar configuration.

It will be appreciated that the illustrative examples shown in the drawings do not in any way limit the applications where the measuring device 10 can be used. The strip 12 forms a bendable ruler that can bend in the directions that are needed to determine the various lengths necessary to perform carpentry tasks, sheet-rocking tasks, flooring tasks, plumbing tasks, etc. The measuring device 10 can be effectively used for measuring lengths of a variety of odd shaped objects, angularly positioned objects, etc.

It is envisioned that the strip 12 may be enclosed in a flexible bendable non-resilient diamagnetic sleeve that will not interfere with the strip's ability to bend without fracturing and retain the bent shape without resiliently returning to its original condition once the bending force is no longer applied. The strip 12 can be formed of any desired length, width and thickness. In one aspect of the invention, the length of the strip 12 is about 36 inches (91.44 cm), about 2 inches (5.08 cm) wide and about 0.25 inch (0.635 cm) thick. Of course, other linear dimensions can be selected if desired. In one aspect of the invention, the strip 12 has a rectangular configuration.

Many changes and modifications can be made in the present invention without departing from the spirit thereof. I, therefore, pray that my rights to the present invention be limited only by the scope of the appended claims.

I claim:

1. A measuring device comprising:
an elongated strip having a normally planar configuration, a first planar surface, a second planar surface oriented parallel to the first planar surface, a first elongated edge and a second elongated edge, and measuring indicia formed on at least the first planar surface along at least the first elongated edge, and wherein said elongated strip is formed from a malleable non-resilient material, the strip being disposed to conform to a shape of an object being measured and to maintain conformed shape for a desired period of time without returning to the normally planar configuration.

2. The device of claim 1, the measuring indicia including successive spaced measuring marks located adjacent to and extending along at least the first elongated edge.

3. The device of claim 1, the measuring indicia including successive spaced measuring marks located adjacent to and extending along at the first elongated edge and the second elongated edge.

4. The device of claim 1, said strip having a substantially rectangular configuration.

5. The device of claim 1, wherein the strip is formed from lead or lead alloy.

6. The device of claim 1, wherein the strip is formed from a flexible bendable material.

7. A measuring device comprising:
an elongated strip having a normally planar rectangular configuration, a first planar surface, a second planar surface oriented parallel to the first planar surface, a first elongated edge and a second elongated edge extending parallel to the first elongated edge, and measuring indicia formed on at least the first planar surface along at least the first elongated edge, and wherein said elongated strip is formed from a malleable non-resilient flexible bendable material, said elongated strip being disposed to conform to a shape of an object being measured and to maintain conformed shape for a desired period of time without returning to the normally planar configuration.

8. The device of claim 7, the measuring indicia including successive spaced measuring marks located adjacent to and extending along at the first elongated edge and the second elongated edge.

9. The device of claim 7, the measuring indicia including successive spaced measuring marks located adjacent to and extending along at least the first elongated edge.

10. The device of claim 7, wherein the strip is formed from lead or lead alloy.

11. A method for tracing a contour of an object, including the steps of:
providing a measuring device comprising an elongated malleable strip having a normally planar configuration, a first planar surface, a second planar surface oriented parallel to the first planar surface, a first elongated edge and a second elongated edge, and measuring indicia formed on at least the first planar surface along at least the first elongated edge;
placing said strip proximate the object being traced;
adjusting the strip sufficient to permit at least a portion of said strip to contact the object being traced and to conform to a shape of a contact surface of the object being traced;
removing said strip from contact with the object being traced; and
recording measured dimensions of the object being traced.

12. The method of claim 11, said strip being formed from a malleable non-resilient material such that the strip maintains the shape of the contact surface of the object being traced and measured and maintains conformed shape for a desired period of time without returning to the normally planar configuration.

13. The method of claim 11, the measuring indicia including successive spaced measuring marks located adjacent to and extending along at the first elongated edge and the second elongated edge.

14. The method of claim 11, the measuring indicia including successive spaced measuring marks located adjacent to and extending along at least the first elongated edge.

15. The method of claim 11, wherein the strip is fanned from lead or lead alloy.
